(19) United States
(12) Patent Application Publication
(10) Pub. No.: US 2021/0357812 A1
(43) Pub. Date: Nov. 18, 2021

(54) LEARNING DEVICE, ESTIMATION DEVICE, LEARNING METHOD, ESTIMATION METHOD, AND PROGRAM

(71) Applicant: NIPPON TELEGRAPH AND TELEPHONE CORPORATION, Tokyo (JP)

(72) Inventors: Yuki KURAUCHI, Tokyo (JP); Naoto ABE, Tokyo (JP); Hiroshi KONISHI, Tokyo (JP); Hitoshi SESHIMO, Tokyo (JP)

(73) Assignee: NIPPON TELEGRAPH AND TELEPHONE CORPORATION, Tokyo (JP)

(21) Appl. No.: 17/277,259

(22) PCT Filed: Sep. 9, 2019
(86) PCT No.: PCT/JP2019/035345

§ 371 Date: Mar. 17, 2021

(30) Foreign Application Priority Data
Sep. 20, 2018 (JP) 2018-176168

(51) Int. Cl. G06N 20/00; G01V 7/06

(52) U.S. Cl. CPC G06N 20/00; G01V 7/06

(57) ABSTRACT

A learning apparatus (10) according to the present invention includes: a normalization/standardization unit (13) that performs normalization or standardization on data detected by a plurality of types of sensors; and a learning unit (14) that builds a model by performing machine learning, using, as training data, the detected data on which normalization or standardization has been performed by the normalization/standardization unit (13). The normalization/standardization unit (13) performs normalization or standardization for each type of sensor, on the data detected by the sensor.

### TECHNICAL FIELD

The present invention relates to a learning apparatus, an estimation apparatus, a learning method, an estimation method, and a program.

### BACKGROUND ART

Studies have been conducted on techniques for estimating the condition (steps, slopes, etc.) of the surface of a road such as a pavement or a roadway on which a moving body such as an automobile, a pedestrian, or a wheelchair moves, by using sensors mounted on the moving body (for example, see NPL 1 and NPL 2).

### CITATION LIST

### [Non Patent Literature]

[NPL 1] Akihiro Miyata, Iori Araki, Tongshun Wang, Tenshi Suzuki, “A Study on Barrier Detection Using Sensor Data of Unimpaired Walkers”, IPSJ journal (2018)

[NPL 2] “Kousoku Basu ni Noseta Sumaho no Kasokudosensadeta de Romen no Outotu wo Kenti, Kensyou Siken wo Zissi (Detecting unevenness of a road surface with an acceleration sensor of a smartphone mounted on an expressway bus, verification tests conducted)” [online] [Searched on Sep. 4, 2018], the Internet <URL: https://sgforum.impress.co.jp/news/3595>

### SUMMARY OF THE INVENTION

### Technical Problem

The condition of a road surface as described above is often estimated using a model that has been built through machine learning performed using, as training data, data detected by sensors that detect the state of a subject. In machine learning, if the average and variance of detected data are significantly different from those of other detected data, the optimal solution cannot be obtained due to pieces of data with a large average and variance being preferentially learned, and appropriate learning cannot be performed.

Therefore, conventionally, normalization or standardization (normalization/standardization) is performed on detected data, and machine learning is performed using the detected data that has been subjected to normalization/standardization, as training data. FIGS. 7A and 7B are diagrams illustrating normalization/standardization of detected data according to a conventional technique. FIGS. 7A and 7B show examples in which detected data is data detected by an acceleration sensor in the directions of three axes (an acceleration X axis, an acceleration Y axis, and an acceleration Z axis), and data detected by a gyro sensor in the directions of three axes (a gyro X axis, a gyro Y axis, and a gyro X axis). In FIGS. 7A and 7B, each dotted square indicates the range of detected data that is to be normalized/standardized.

Conventionally, normalization/standardization has been performed on all of the pieces of data detected by the sensors at once, as shown in FIG. 7A, or on each detection item, as shown in FIG. 7B.

In general, the average and variance of detected values significantly vary depending on the type of the sensor. For example, values detected by an acceleration sensor (for example, −9.8 to 9.8 (m/s²)) and values detected by an atmospheric pressure sensor (for example, 870 to 1080 (hPa)) have significantly different averages and variances. If such pieces of data with significantly different averages and variances, detected by a plurality of types of sensors, are subjected to normalization/standardization all at once as shown in FIG. 7A, the differences between the averages and the variances of the sensors cannot be absorbed. As a result, even if machine learning is performed using the detected data that has been subjected to normalization/standardization as training data, sufficient training accuracy cannot be obtained.

Furthermore, when the directions of the plurality of sensors are not uniform, the values detected by the sensor are corrected by rotating the directions of the sensors so that the directions of the sensors are made uniform. Here, if normalization/standardization is performed on each detection item as shown in FIG. 7B, changes in the value range caused due to the values detected by the sensor being corrected, cannot be absorbed. As a result, even if machine learning is performed using the detected data that has been subjected to normalization/standardization as training data, sufficient training accuracy cannot be obtained.

Although machine learning of a model performed using training data has been described so far, estimation using a model also requires that normalization/standardization be performed on data input to the model. Therefore, as in the case of machine learning, it is not possible to achieve sufficient accuracy in estimation using a conventional normalization/standardization method.

An object of the present invention made in view of the above-described problems is to provide a learning apparatus, an estimation apparatus, a learning method, an estimation method, and a program that are capable of improving accuracy in performing machine learning on a model using training data, and in performing estimation using a model.

### Means for Solving the Problem

To solve the above-described problems, a learning apparatus according to the present invention is a learning apparatus that builds a model by performing machine learning, using, as training data, data detected by a plurality of types of sensors that detect a state of a subject, the learning apparatus including: a normalization/standardization unit that performs normalization or standardization on data detected by the plurality of types of sensors; and a learning unit that builds the model by performing machine learning, using, as training data, the detected data on which normalization or standardization has been performed by the normalization/standardization unit. The normalization/standardization unit performs normalization or standardization for each type of sensor, on data detected by the sensor.

Also, to solve the above-described problems, an estimation apparatus according to the present invention is an estimation apparatus that estimates a state of a subject, using a model that has been built through machine learning performed using, as training data, data detected by a plurality of types of sensors that detect the state of the subject, the estimation apparatus including: a normalization/standardization unit that performs normalization or standardization on data detected by the plurality of types of sensors; and an estimation unit that estimates the state of the subject by applying the detected data on which normalization or standardization has been performed by the normalization/standardization unit, to the model. The normalization/standardization unit performs normalization or standardization for each type of sensor, on data detected by the sensor.

Also, to solve the above-described problems, a learning method according to the present invention is a learning method that is to be used by a learning apparatus that builds a model by performing machine learning, using, as training data, data detected by a plurality of types of sensors that detect a state of a subject, the learning method including: a normalization/standardization step of performing normalization or standardization on data detected by the plurality of types of sensors; and a learning step of building the model by performing machine learning, using, as training data, the detected data on which normalization or standardization has been performed. In the normalization/standardization step, normalization or standardization is performed for each type of sensor, on data detected by the sensor.

Also, to solve the above-described problems, an estimation method according to the present invention is an estimation method that is to be performed by an estimation apparatus that estimates a state of a subject, using a model that has been built through machine learning performed using, as training data, data detected by a plurality of types of sensors that detect the state of the subject, the estimation method including: a normalization/standardization step of performing normalization or standardization on data detected by the plurality of types of sensors; and an estimation step of estimating the state of the subject by applying the detected data on which normalization or standardization has been performed, to the model. In the normalization/standardization step, normalization or standardization is performed for each type of sensor, on data detected by the sensor.

Also, to solve the above-described problems, a program according to the present invention enables a computer to function as the above-described learning apparatus.

Also, to solve the above-described problems, a program according to the present invention enables a computer to function as the above-described estimation apparatus.

### Effects of the Invention

With the learning apparatus, the estimation apparatus, the learning method, the estimation method, and the program according to the present invention, it is possible to improve accuracy in performing machine learning on a model, using training data, and in performing estimation, using a model.

### BRIEF DESCRIPTION OF DRAWINGS

FIG. 1 is a diagram showing an example of a configuration of a learning apparatus according to an embodiment of the present invention.

FIG. 2 is a diagram showing an example of a configuration of an estimation apparatus according to an embodiment of the present invention.

FIG. 3 is a diagram illustrating normalization/standardization performed by normalization/standardization units shown in FIGS. 1 and 2.

FIG. 4 is a diagram showing normalization/standardization performed by the normalization/standardization units shown in FIGS. 1 and 2.

FIG. 5 is a flowchart illustrating a learning method that is to be carried out by the learning apparatus shown in FIG. 1.

FIG. 6 is a flowchart illustrating an estimation method that is to be carried out by the estimation apparatus shown in FIG. 1.

FIG. 7A is a diagram illustrating conventional normalization/standardization.

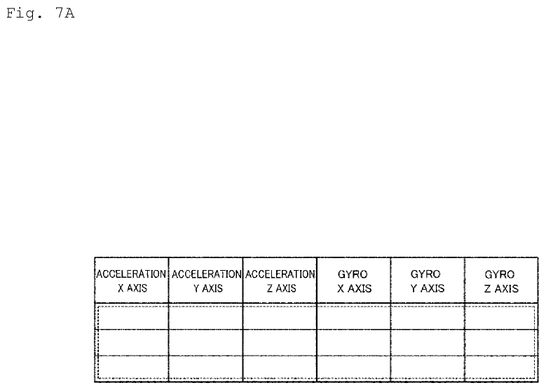

FIG. 7B is a diagram illustrating conventional normalization/standardization.

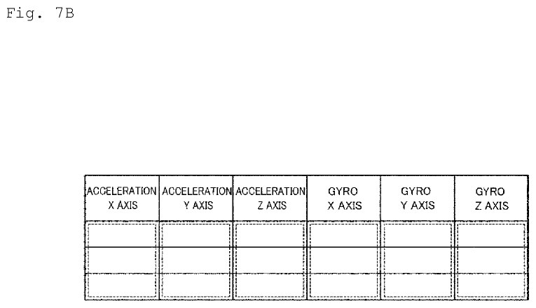

### DESCRIPTION OF EMBODIMENTS

Hereinafter, an embodiment for carrying out the present invention will be described with reference to the drawings. In the drawings, the same reference numerals indicate the same or equivalent constituent elements.

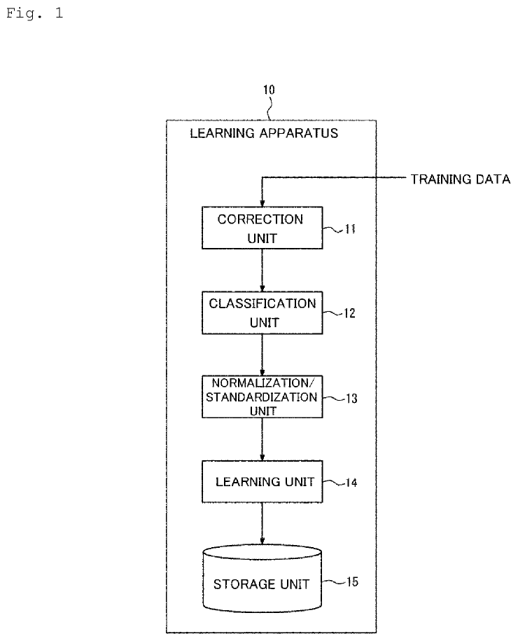

FIG. 1 is a diagram showing an example of a configuration of a learning apparatus 10 according to an embodiment of the present invention. The learning apparatus 10 according to the present embodiment builds a model by performing machine learning using training data. More specifically, the learning apparatus 10 according to the present embodiment builds a model that is used to estimate the state of a subject, by performing machine learning using, as training data, data detected by a plurality of types of sensors that detect the state of a subject. The state of a subject is, for example, the condition of a road surface (whether or not the road surface is flat, whether or not there is a step, etc.). In such a case, training data is road surface data that indicates the condition of the surface of a road on which a moving body such as an automobile, a pedestrian, or a wheelchair moves, by using a plurality of types of sensors mounted on the moving body. The learning apparatus 10 builds a model that is used to estimate the condition of the road surface.

The learning apparatus 10 shown in FIG. 1 includes a correction unit 11, a classification unit 12, a normalization/standardization unit 13, a learning unit 14, and a storage unit 15.

Data detected by a plurality of types of sensors that detect the state of the subject is input to the correction unit 11 as training data. Note that detected data to which teacher labels indicating the state of the subject indicated by the detected data is added is used as the learning data. However, a description of the teacher labels is omitted below. Various sensors such as an acceleration sensor, a gyro sensor, a geomagnetic sensor, a gravity sensor, an atmospheric pressure sensor, and a tilt sensor may be used as the sensors that detect the state of the subject according to the need, depending on the subject of estimation. In the following description, the plurality of types of sensors include a gravity sensor.

The correction unit 11 corrects data detected by sensors (for example, an acceleration sensor, a gyro sensor, a geomagnetic sensor, and a tilt sensor) that detect the state of the subject in predetermined axis directions (movement of the subject, a tilt, etc.), other than the gravity sensor, of the plurality of types of sensors, based on data detected by the gravity sensor. Specifically, the correction unit 11 corrects values detected by the sensors by rotating the directions of the sensors with reference to the direction of gravity detected by the gravity sensor so that the directions of the sensors are made uniform.

The correction unit 11 obtains r, θ, and φ that satisfy Expression (1) shown below, where g=(x,y,t)^{T} denotes a value from the gravity sensor (T denotes transposition), R_{z} (φ) denotes a rotation matrix for rotation about the Z axis, and R_{y} (φ) denotes a rotation matrix for rotation about the Y axis. The correction unit 11 corrects the values detected by the sensors by applying an expression obtained by substituting r, θ, and φ thus obtained into Expression 1, to the values detected by the sensors.

$$\begin{matrix} [ Formula 1 ] & \\ {rR}_{z} ( θ ) {R}_{y} ( ϕ ) g = r ( \begin{matrix}cos θ & - sin θ & 0 \\ sin θ & cos θ & 0 \\ 0 & 0 & 1\end{matrix} ) ( \begin{matrix}cos ϕ & 0 & sin ϕ \\ 0 & 1 & 0 \\ - sin ϕ & 0 & cos ϕ\end{matrix} ) ( \begin{matrix}x \\ y \\ z\end{matrix} ) = ( \begin{matrix}cos θ cos ϕ & - sin θ & cos θ sin ϕ \\ sin θ cos ϕ & cos θ & sin θ sin ϕ \\ - sin ϕ & 0 & cos ϕ\end{matrix} ) ( \begin{matrix}x \\ y \\ z\end{matrix} ) = r ( \begin{matrix}x cos θ cos ϕ - y sin θ + z cos θ sin ϕ \\ x sin θ cos ϕ + y cos θ + z sin θ sin ϕ \\ - z sin ϕ + z cos ϕ\end{matrix} ) = ( \begin{matrix}1 \\ 0 \\ 0\end{matrix} ) & Expression 1\end{matrix}$$

The correction unit 11 outputs the corrected detected data to the classification unit 12. Note that, if the directions of the sensors have been made uniform in advance, the correction unit 11 need not perform correction.

The classification unit 12 classifies the pieces of detected data output from the correction unit 11, according to the types of the sensors, and outputs them to the normalization/standardization unit 13.

The normalization/standardization unit 13 performs normalization or standardization (normalization/standardization) (at least one of normalization and standardization) on the pieces of detected data output from the classification unit 12. Specifically, the normalization/standardization unit 13 performs normalization/standardization on the pieces of detected data classified by the classification unit 12 according to the types of the sensors, and the normalization/standardization unit 13 performs normalization/standardization for each type of sensor, on data detected by the sensor. The normalization/standardization unit 13 outputs the pieces of detected data that have been subjected to the normalization/standardization, to the learning unit 14.

The learning unit 14 performs machine learning using the detected data subjected to the normalization/standardization performed by the normalization/standardization unit 13 as training data, to build a model that is used to estimate the state of the subject.

The storage unit 15 stores the model built by the learning unit 14.

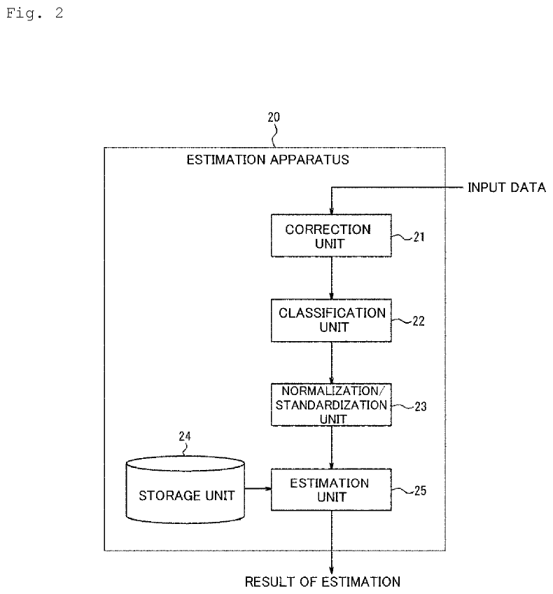

FIG. 2 is a diagram showing an example of a configuration of an estimation apparatus 20 according to an embodiment of the present invention. The estimation apparatus 20 according to the present embodiment estimates the state of the subject, using the model built by the learning apparatus 10.

The estimation apparatus 20 shown in FIG. 2 includes a correction unit 21, a classification unit 22, a normalization/standardization unit 23, a storage unit 24, and an estimation unit 25.

Data detected by a plurality of types of sensors that are attached to the subject of which the state is to be estimate is input to the correction unit 21 as input data. In the following description, the plurality of types of sensors include a gravity sensor.

The correction unit 21 corrects data detected by sensors (for example, an acceleration sensor, a gyro sensor, a geomagnetic sensor, and a tilt sensor) that detect the state of the subject in predetermined axis directions (movement of the subject, a tilt, etc.), other than the gravity sensor, of the plurality of types of sensors, based on data detected by the gravity sensor. Specifically, as with the correction unit 11 of the learning apparatus 10, the correction unit 21 corrects the detected data according to Expression 1. The correction unit 21 outputs the corrected detected data to the classification unit 22.

The classification unit 22 classifies the pieces of detected data output from the correction unit 21, according to the types of the sensors, and outputs them to the normalization/standardization unit 23.

The normalization/standardization unit 23 performs normalization/standardization (at least one of normalization and standardization) on the pieces of detected data output from the classification unit 22. Specifically, the normalization/standardization unit 23 performs normalization/standardization on the pieces of detected data classified by the classification unit 22 according to the types of the sensors, and the normalization/standardization unit 23 performs normalization/standardization for each type of sensor, on data detected by the sensor. The normalization/standardization unit 23 outputs the pieces of detected data that have been subjected to the normalization/standardization, to the estimation unit 25.

The storage unit 24 stores the model built by the learning apparatus 10.

The estimation unit 25 estimates the state of the subject by applying the detected data subjected to the normalization/standardization performed by the normalization/standardization unit 23, to the model stored in the storage unit 24. Specifically, the estimation unit 25 inputs the detected data output from the normalization/standardization unit 23, to the model, and outputs an output from the model as the result of estimation of the state of the subject.

Next, normalization/standardization performed by the normalization/standardization unit 13 and the normalization/standardization unit 23 will be described. Note that the normalization/standardization unit 13 and the normalization/standardization unit 23 employ the same normalization/standardization method. Therefore, the following describes the normalization/standardization unit 13 as an example, and a description of the normalization/standardization unit 23 will be omitted.

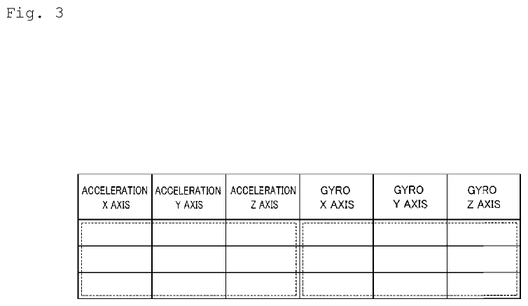

As described above, the normalization/standardization unit 13 performs normalization/standardization for each type of sensor, on data detected by the sensor. That is to say, as shown in FIG. 3, the normalization/standardization unit 13 performs normalization/standardization on pieces of data detected by the same type of sensors, all at once. In the example in FIG. 3, the normalization/standardization unit 13 performs normalization/standardization on the pieces of data detected by the acceleration sensor (an acceleration X, an acceleration Y, and an acceleration Z) all at once, and on the pieces of data detected by the gyro sensor (a gyro X, a gyro Y, and a gyro Z) all at once. In FIG. 3, each dotted square indicates the range of detected data that is to be normalized/standardized.

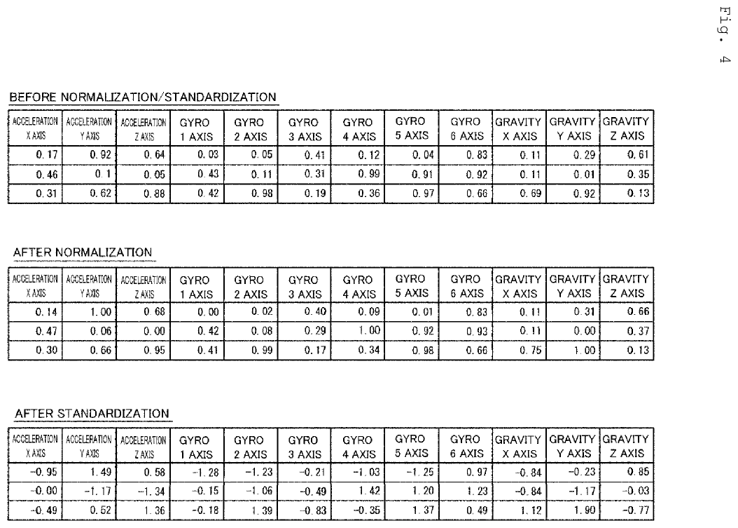

FIG. 4 is a diagram showing a specific example of normalization/standardization performed by the normalization/standardization unit 13.

FIG. 4 show examples in which the pieces of detected data are accelerations in three axis directions (an acceleration X, an acceleration Y, and an acceleration Z) detected by the acceleration sensor, accelerations in the roll axis, pitch axis, and yaw axis directions, and angular velocities in the roll axis, pitch axis, and yaw axis directions (a gyro 1 axis, a gyro 2 axis, a gyro 3 axis, a gyro 4 axis, a gyro 5 axis, and a gyro 6 axis) detected by the gyro sensor, and accelerations in three axis directions caused by gravity (a gravity X, a gravity Y, and a gravity Z) detected by the gravity sensor.

As described above, the normalization/standardization unit 13 performs normalization/standardization for each type of sensor, on data detected by the sensor. Therefore, in the case of the example shown in FIG. 4, the normalization/standardization unit 13 performs normalization/standardization on the pieces of data detected by the acceleration sensor (the acceleration X, the acceleration Y, and the acceleration Z) all at once, performs normalization/standardization on the pieces of data detected by the gyro sensor (the gyro 1 axis, the gyro 2 axis, the gyro 3 axis, the gyro 4 axis, the gyro 5 axis, and the gyro 6 axis) all at once, and performs normalization/standardization on the pieces of data detected by the gravity sensor (the gravity X, the gravity Y, and the gravity Z) all at once.

The normalization/standardization unit 13 performs normalization according to Expression 2 shown below, and performs standardization according to Expression 3 shown below, where x denotes a value detected by a sensor, x′ denotes a detection value that has been subjected to normalization/standardization, and max, min, avr, and std respectively denote the maximum value, the minimum value, the average, and the variance of values detected by each type of sensor.

x′=(x−min)/(max−min) Expression 2

x′=(x−avr)/std Expression 3

In the example in FIG. 4, the minimum value, the maximum value, the average, and the variance of the values detected by the acceleration sensor (the acceleration X, the acceleration Y, and the acceleration Z) are 0.92, 0.05, 0.46, and 0.31, respectively. The minimum value, the maximum value, the average, and the variance of the pieces of data detected by the gyro sensor (the gyro 1 axis, the gyro 2 axis, the gyro 3 axis, the gyro 4 axis, the gyro 5 axis, and the gyro 6 axis) are 0.99, 0.03, 0.49, and 0.36, respectively. The minimum value, the maximum value, the average, and the variance of the pieces of data detected by the gravity sensor (the gravity X, the gravity Y, and the gravity Z) are 0.92, 0.01, 0.36, and 0.30, respectively. FIG. 4 shows the results of normalization/standardization performed based on these values.

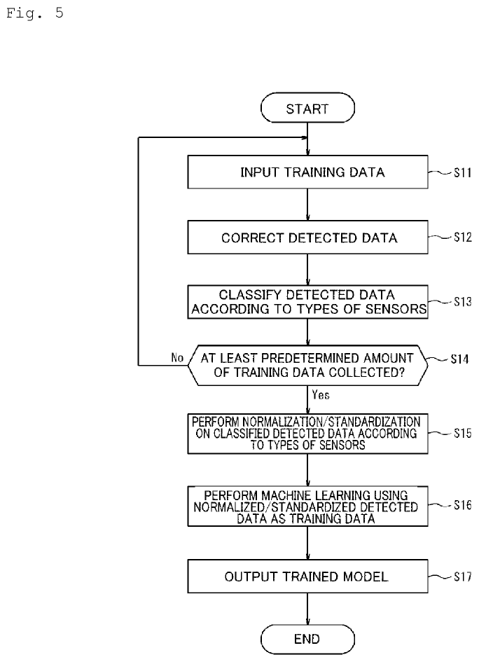

Next, a learning method performed by the learning apparatus 10 according to the present embodiment will be described with reference to the flowchart shown in FIG. 5.

Upon receiving pieces of input detected data as training data (step S11), the correction unit 11 corrects the input detected data to make the directions of the sensors uniform (step S12).

The classification unit 12 classifies the pieces of detected data thus corrected by the correction unit 11, according to the types of the sensors (step S13).

The normalization/standardization unit 13 determines whether or not at least a predetermined amount of detected data (training data), classified by the classification unit 12 according to the types of the sensors, has been collected (step S14).

Upon determining that at least the predetermined amount of training data has not been collected (step S14: No), processing returns to step S11, and new training data is input to the correction unit 11.

Upon determining that at least the predetermined amount of training data has been collected (step S14: Yes), the normalization/standardization unit 13 performs normalization/standardization on the pieces of detected data classified by the classification unit 12 according to the types of the sensors (step S15).

The learning unit 14 performs machine learning on a learning model, using the detected data normalized/standardized by the normalization/standardization unit 13 as training data (step S16), to build a trained model. Thereafter, the learning unit 14 outputs the trained model thus built (step S17). Note that various models, including a model using the convolutional neural network, the SVM (Support Vector Machine), and so on, may be used as the learning model.

As described with reference to FIG. 5, the learning method performed by the learning apparatus 10 according to the present embodiment includes a normalization/standardization step of performing normalization or standardization on data detected by a plurality of types of sensors (step S15) and a learning step of performing machine learning, using the detected data that has been subjected to normalization or standardization as training data, to build a model (step S16). Here, in the normalization/standardization step, normalization or standardization is performed for each type of sensor, on data detected by the sensor.

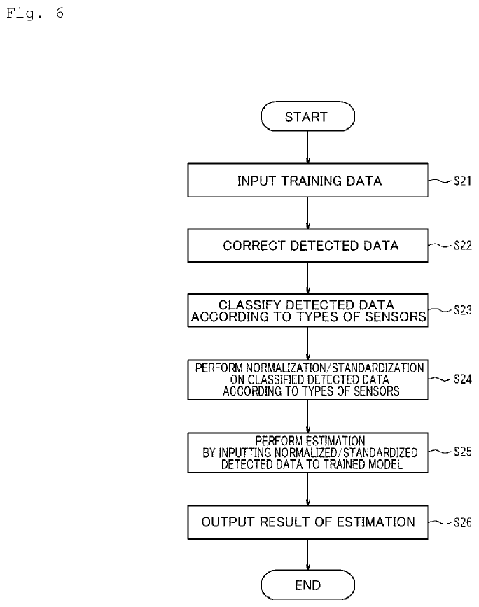

Next, an estimation method performed by the estimation apparatus 20 according to the present embodiment will be described with reference to the flowchart shown in FIG. 6.

Upon receiving, as input data, pieces of data detected by the plurality of types of sensors that detect the state of the subject (step S21), the correction unit 21 corrects the input detected data to make the directions of the sensors uniform (step S22).

The classification unit 22 classifies the pieces of detected data thus corrected by the correction unit 21, according to the types of the sensors (step S23).

The normalization/standardization unit 23 performs normalization/standardization on the pieces of detected data classified by the classification unit 22 according to the types of the sensors (step S24).

The estimation unit 25 estimates the state of the subject by inputting the detected data normalized/standardized by the normalization/standardization unit 23 to the trained model built by the learning apparatus 10 (step S25), and outputs an output from the trained model as the result of estimation (step S26).

As described with reference to FIG. 6, the estimation method performed by the estimation apparatus 20 according to the present embodiment includes a normalization/standardization step of performing normalization/standardization on data detected by a plurality of types of sensors (step S24), and an estimation step of estimating the state of the subject by applying the detected data that has been subjected to normalization/standardization, to the model (step S25). Here, in the normalization/standardization step, the normalization/standardization unit 13 performs normalization/standardization for each type of sensor, on data detected by the sensor.

In this way, in the present embodiment, the learning apparatus 10 includes a normalization/standardization unit 13 that performs normalization or standardization on pieces of data detected by a plurality of types of sensors, and a learning unit 14 that builds a model by performing machine learning, using, as training data, the detected data on which normalization or standardization has been performed by the normalization/standardization unit 13. The normalization/standardization unit 13 performs normalization or standardization for each type of sensor, on data detected by the sensor.

Also, in the present embodiment, the estimation apparatus 20 includes a normalization/standardization unit 23 that performs normalization or standardization on data detected by a plurality of types of sensors, and an estimation unit 25 that estimates the state of the subject by applying the detected data that has been normalized or standardized by the normalization/standardization unit 23, to a model. The normalization/standardization unit 23 performs normalization or standardization for each type of sensor, on data detected by the sensor.

By performing normalization or standardization on detected data for each type of sensor, it is possible to perform normalization or standardization considering the differences between the averages/variances of the values detected by the sensors. In addition, by performing normalization or standardization on detected data for each type of sensor, it is possible to perform normalization or standardization considering changes in the value range caused due to the values detected by the sensor being corrected in order to make the directions of the sensors uniform. Therefore, with the learning apparatus 10 and the estimation apparatus 20 according to the present embodiment, it is possible to improve accuracy in performing machine learning on a model, using training data, and in performing estimation, using a model.

While the learning apparatus 10 and the estimation apparatus 20 have been described above, a computer may be used so as to function as the learning apparatus 10 and the estimation apparatus 20. Such a computer can be realized by storing a program that describes the content of processing performed to realize the functions of the learning apparatus 10 and the estimation apparatus 20, in a storage unit of the computer, and causing a CPU of the computer to read out and execute the program.

The program may be recorded on a computer-readable recording medium. By using such a recording medium, it is possible to install the program to a computer. Here, the recording medium on which the program is recorded may be a non-transitory recording medium. A non-transitory recording medium is not specifically limited, and may be a recording medium such as a CD-ROM or a DVD-ROM, for example.

Although the above embodiment has been described as a presentative example, it is obvious for a person skilled in the art that various modifications and replacements may be applied within the spirit and the scope of the present invention. Therefore, the present invention should not be construed as being limited by the above-described embodiment, and various modifications and changes may be made without departing from the scope of the claims. For example, in the configuration according to the present invention, it is possible to combine a plurality of constituent blocks described in the configuration diagram according to the embodiment into one block, or to divide one constituent block into a plurality of blocks.

### REFERENCE SIGNS LIST

10 Learning apparatus

11 Correction unit

12 Classification unit

13 Normalization/standardization unit

14 Learning unit

15 Storage unit

20 Specification apparatus

21 Correction unit

22 Classification unit

23 Normalization/standardization unit

24 Storage unit

25 Estimation unit

1. A apparatus that builds a model by performing machine learning, using, as training data, data detected by a plurality of types of sensors that detect a state of a subject, the apparatus comprising:
a normalizer-standardizer configured to perform normalization or standardization on data detected by the plurality of types of sensors; and
a learner configured to build the model by performing machine learning, using, as training data, the detected data on which normalization or standardization has been performed by the normalizer-standardizer, wherein the normalizer-standardizer performs normalization or standardization for each type of sensor, on data detected by the sensor.

2. The apparatus according to claim 1, wherein the plurality of types of sensors include a gravity sensor that detects a direction of gravity, the learning apparatus further comprises a corrector configured to correct data detected by a sensor that detects the state of the subject in a predetermined axis direction, other than the gravity sensor, of the plurality of types of sensors, based on data detected by the gravity sensor, and the normalizer-standardizer performs normalization or standardization on the detected data that has been corrected by the corrector.

3. The apparatus according to claim 1, wherein the apparatus estimates a state of a subject, using a model that has been built through machine learning performed using, as training data, data detected by a plurality of types of sensors that detect the state of the subject, the learning apparatus further comprising:
an estimator configured to estimate the state of the subject by applying the detected data on which normalization or standardization has been performed by the normalizer-standardizer, to the model, wherein the normalizer-standardizer performs normalization or standardization for each type of sensor, on data detected by the sensor.

4. The apparatus according to claim 3, wherein the plurality of types of sensors include a gravity sensor that detects a direction of gravity, the apparatus further comprises a corrector that corrects data detected by a sensor that detects the state of the subject in a predetermined axis direction, other than the gravity sensor, of the plurality of types of sensors, based on data detected by the gravity sensor, and the normalizer-standardizer performs normalization or standardization on the detected data that has been corrected by the corrector.

5. (canceled)

6. A method that is to be performed by an apparatus that estimates a state of a subject, using a model that has been built through machine learning performed using, as training data, data detected by a plurality of types of sensors that detect the state of the subject, the estimation method comprising:
performing, by a normalizer-standardizer, normalization or standardization on data detected by the plurality of types of sensors; and
estimating, by an estimator, the state of the subject by applying the detected data on which normalization or standardization has been performed, to the model, wherein, in the normalization/standardization step, normalization or standardization is performed for each type of sensor, on data detected by the sensor.

7. A computer-readable non-transitory recording medium storing computer-executable instructions that when executed by a processor cause a computer system to:
perform, by a normalizer-standardizer, normalization or standardization on data detected by the plurality of types of sensors; and
perform, by a learner, machine learning, using, as training data, the detected data on which normalization or standardization has been performed, wherein the performing includes normalization or standardization of each type of sensor, on data detected by the sensor.

8. The computer-readable non-transitory recording medium according to claim 7, wherein the apparatus estimates a state of a subject, using a model that has been built through machine learning performed using, as training data, data detected by a plurality of types of sensors that detect the state of the subject, the computer-executable instructions when executed further causing the computer system to:
estimate, by an estimator, the state of the subject by applying the detected data on which normalization or standardization has been performed by the normalizer-standardizer, to the model, wherein the normalizer-standardizer performs normalization or standardization for each type of sensor, on data detected by the sensor.

9. The method according to claim 6 associated with the apparatus that builds a model by performing machine learning, using, as training data, data detected by a plurality of types of sensors that detect a state of a subject, the method further comprising:
performing, by a learner, a learning step of building the model by performing machine learning, using, as training data, the detected data on which normalization or standardization has been performed, wherein the performing by the normalizer-standardizer includes normalization or standardization is performed for of each type of sensor, on data detected by the sensor.

10. The method according to claim 6, wherein the plurality of types of sensors include a gravity sensor that detects a direction of gravity, the method further comprising:
correcting, by a corrector, data detected by a sensor that detects the state of the subject in a predetermined axis direction, other than the gravity sensor, of the plurality of types of sensors, based on data detected by the gravity sensor; and
performing, by the normalizer-standardizer performs normalization or standardization on the detected data that has been corrected by the corrector.

11. The method according to claim 9, wherein the plurality of types of sensors include a gravity sensor that detects a direction of gravity, the method further comprising:
correcting, by a corrector, data detected by a sensor that detects the state of the subject in a predetermined axis direction, other than the gravity sensor, of the plurality of types of sensors, based on data detected by the gravity sensor; and
performing, by the normalizer-standardizer performs normalization or standardization on the detected data that has been corrected by the corrector.

12. The computer-readable non-transitory recording medium of claim 7, wherein the plurality of types of sensors include a gravity sensor that detects a direction of gravity, the computer-executable instructions when executed further causing the computer system to:
correct, by a corrector, data detected by a sensor that detects the state of the subject in a predetermined axis direction, other than the gravity sensor, of the plurality of types of sensors, based on data detected by the gravity sensor; and
perform, by the normalizer-standardizer performs normalization or standardization on the detected data that has been corrected by the corrector.

13. The computer-readable non-transitory recording medium of claim 8, wherein the plurality of types of sensors include a gravity sensor that detects a direction of gravity, the computer-executable instructions when executed further causing the computer system to:
correct, by a corrector, data detected by a sensor that detects the state of the subject in a predetermined axis direction, other than the gravity sensor, of the plurality of types of sensors, based on data detected by the gravity sensor; and
perform, by the normalizer-standardizer performs normalization or standardization on the detected data that has been corrected by the corrector.
